(19) United States
(12) Patent Application Publication
(10) Pub. No.: US 2026/0332000 A1
(43) Pub. Date: Oct. 22, 2026

(54) COOLING SYSTEM FOR A SUPERCONDUCTING GENERATOR

(71) Applicant: General Electric Renovables España, S.L., Barcelona (ES)

(72) Inventors: Ernst Wolfgang Stautner, Niskayuna, NY (US); Minfeng Xu, Ballston Lake, NY (US); Anbo Wu, Clifton Park, NY (US)

(21) Appl. No.: 19/115,901

(22) PCT Filed: Sep. 28, 2022
(86) PCT No.: PCT/US2022/044979

§ 371 Date: Mar. 27, 2025

(51) Int. Cl. H02K 9/22; H02K 9/10; H02K 55/00

(52) U.S. Cl. CPC H02K 9/223; H02K 9/10; H02K 55/00; H02K 2213/03

(57) ABSTRACT

A cooling system for a superconducting machine includes a thermal shield, a cryocooler, and an extension member. The cryocooler is thermally coupled to the thermal shield via at least one thermal busbar and at least one flexible connector, the at least one thermal busbar secured across the at least one flexible connector. The extension member is secured to the at least one thermal busbar and the thermal shield so as to position the at least one thermal busbar at a location that minimizes a length of the at least one flexible connector.

### RELATED APPLICATION

The present application claims priority to PCT Application No. PCT/US2022/044979, filed Sep. 28, 2022, which is incorporated by reference herein in its entirety.

### STATEMENT REGARDING FEDERALLY SPONSORED RESEARCH OR DEVELOPMENT

This invention was made with Government support under Contract No. DE-FOA-0001981 awarded by the Department of Energy (DOE). The Government has certain rights in the invention.

### FIELD

The present disclosure relates to superconducting machines, and more particularly, to improved cooling systems for superconducting machines.

### BACKGROUND

Wind turbines have received increased attention as an environmentally safe and relatively inexpensive alternative energy source. With this growing interest, considerable efforts have been made to develop wind turbines that are reliable and efficient. Generally, a wind turbine includes a plurality of rotor blades coupled via the rotor hub to the main shaft of the turbine. The rotor hub is positioned on top of a tubular tower or base. Utility grade wind turbines (i.e., wind turbines designed to provide electrical power to a utility grid) can have large rotors (e.g., 100 or more meters in diameter). The rotor blades convert wind energy into a rotational torque or force that drives the generator, rotationally coupled to the rotor.

Low reactance machines (e.g., superconducting generators) are being explored for use in wind turbine installations, particularly in offshore installations. These machines use superconducting field windings and assemblies of armature coils, cooling systems, and nonmagnetic teeth disposed between coils in the armature. In a particular design, the superconducting generator includes an armature winding assembly that, unlike conventional machine (e.g., conventional, non-superconducting generator) configurations, rotates within a superconducting field assembly, which includes a cryostat with superconducting field coils inside the cryostat.

During operation, the superconducting magnet windings must be cooled below their critical temperature (i.e., the temperature at which the winding material changes from the normal resistive state and becomes a superconductor). Typically, the windings are cooled to temperatures significantly below their critical temperature, because the lower the temperature, the better the superconductive windings work. In addition, a lower temperature enables the superconductive windings to withstand higher currents and magnetic fields without returning to their non-superconductive state. Thus, liquid cooling or mechanical cooling are commonly used to maintain the windings at temperatures sufficient to maintain superconductivity. In liquid cooling, liquid helium may be used as a coolant, which has a boiling point of 4.2 Kelvin that is below the critical temperature of most winding materials. Thus, the superconducting magnet and the liquid helium are contained in a thermally insulated container called a cryostat. Alternatively, mechanical cooling may generally include cooling of the superconducting magnet using two-stage mechanical refrigeration.

To further the efficiency of cooling, various components of the cooling system and superconducting generator may be arranged in separate regions within the superconducting machine so the components can be maintained at different temperatures. By separating the components in this manner, undesired thermal transfer between the components may be reduced. However, displacement and motion between such components due to thermal expansion and contraction must be accounted for.

In addition, undesirable thermal contact resistances may occur as a result of securing different components to each other to form the cooling system. If such resistances increase above a certain threshold, the increase may result in the superconducting generator operating sub-optimally or the windings operating in a non-superconducting state.

Thus, the present disclosure is directed to an improved cooling system for a superconductive generator that addresses the aforementioned issues.

### BRIEF DESCRIPTION

Aspects and advantages of the present disclosure will be set forth in part in the following description, or may be obvious from the description, or may be learned through practice of the present disclosure.

In one aspect, the present disclosure is directed to a cooling system for a superconducting machine. The cooling system includes a thermal shield, a cryocooler, and an extension member. The cryocooler is thermally coupled to the thermal shield via at least one thermal busbar and at least one flexible connector, or multiple flexible connectors with the at least one thermal busbar secured across the one or more flexible connectors. The extension member is integral with or thermally secured between the at least one thermal busbar and the thermal shield so as to position the at least one thermal busbar at a location that minimizes a length of the at least one flexible connector.

In an embodiment, the extension member includes at least one bend.

In further embodiments, the at least one bend defines an angle ranging from about 30 degrees to about 150 degrees

In additional embodiments, the extension member includes a plurality of member components secured together to form the least one bend

In other embodiments, at least a portion of the extension member is integral with the at least one thermal busbar

In still further embodiments, the extension member is a separate component from the at least one thermal busbar

In other additional embodiments, the at least one flexible connector includes a plurality of flexible connectors, wherein the extension member includes a twisted portion including a wider surface to allow the plurality of flexible connectors to have approximately a same length

In further additional embodiments, the at least one flexible connector includes a length ranging from about 50 millimeters (mm) to less than about 300 mm.

In still other embodiments, the at least one flexible connector includes one of a braided wire, a foil member, or a heat pipe

In yet another embodiment, the extension member defines one of an L-shape, a U-shape, an I-shape, or an S-shape.

In another aspect, the present disclosure is directed to a method of cooling a superconducting machine. The method includes positioning a thermal shield circumferentially around a cold mass of the superconducting machine. The method also includes thermally coupling a cryocooler to the thermal shield via a plurality of flexible connectors and a thermal busbar secured across the plurality of flexible connectors. The method still further includes securing an extension member between the thermal busbar and the thermal shield, wherein the extension member is integral with or separate from the thermal bus bar and positions the thermal busbar at a location with respect to the cryocooler that minimizes a length of the plurality of flexible connectors. The method yet further includes operating the cryocooler to cool the superconducting machine.

In yet another embodiment, the present disclosure is directed to a superconducting machine. The superconducting machine includes a cold mass, a thermal shield, a cryocooler, and an extension member. The cold mass includes a plurality of superconducting coils. The thermal shield encompasses the cold mass. The cryocooler is thermally coupled to the thermal shield via at least one thermal busbar and one or more flexible connectors, the at least one thermal busbar secured across the one or more flexible connectors. The extension member is configured between the at least one thermal busbar and the thermal shield so as to position the at least one thermal busbar at a location that minimizes a length of the at least one flexible connector.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates an embodiment of a superconducting machine that may be housed within a nacelle of a wind turbine according to the present disclosure;

FIG. 2 illustrates a perspective view of an embodiment of a superconducting machine;

FIG. 3 illustrates an internal, perspective view of an embodiment of a superconducting machine;

FIG. 4 illustrates a simplified, cross-sectional view of a superconducting machine;

FIG. 5 illustrates a partial, internal view of an embodiment of a superconducting machine according to the present disclosure, particularly illustrating details of a cooling system of the superconducting machine;

FIG. 6 illustrates a partial, perspective view of an embodiment of a thermal shield of a superconducting machine according to an embodiment of the present disclosure;

FIGS. 7A-7C illustrate various embodiments of extension members that can be secured to a thermal busbar and a thermal shield of a superconducting machine to position the thermal busbar at a location that minimizes a length of a flexible connector according to the present disclosure; and

FIG. 8 illustrates a flow diagram of an embodiment of a method of cooling a superconducting machine according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

In general, the present disclosure is directed to a cooling system for a superconducting generator. In an embodiment, for example, the superconducting generator may include a thermal shield, a cryocooler, and an extension member. The cryocooler is thermally coupled to the thermal shield by a thermal busbar and at least one flexible connector. Further, in an embodiment, the thermal busbar is secured across the flexible connector(s). Thus, the extension member is secured to the thermal busbar and the thermal shield to position the thermal busbar at a location that minimizes the length of the flexible connector(s). Accordingly, the length of the flexible connector(s) can be minimized, thereby reducing thermal conduction losses, and improving the efficiency of the cooling system.

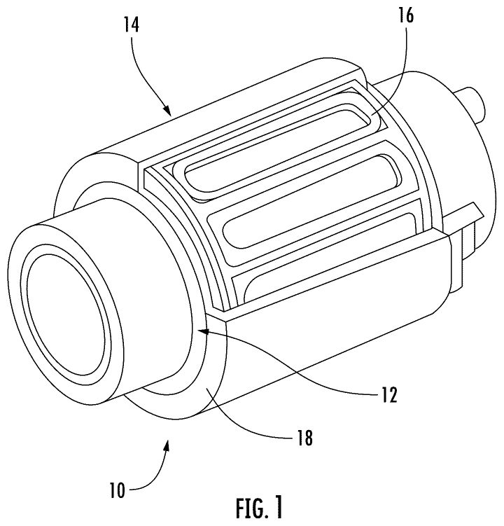

Referring now to the figures, FIG. 1 illustrates a perspective view of a superconducting machine 10 that may be housed within a nacelle of a wind turbine. As shown, the superconducting machine 10 may include an armature winding assembly 12, a field winding assembly 14, a plurality of conducting coils 16 (such as superconducting or non-superconducting coils), and a thermally insulated vacuum vessel 18. Thus, in an embodiment, the field winding assembly 14 may be a stationary component of the superconducting machine 10 with a first electromagnetic component configuration in the form of the conducting coils 16 that provide a magnetic field in which the armature winding assembly 12 with a second electromagnetic component configuration rotates. However, in other embodiments, it should be understood that the armature winding assembly 12 may instead be stationary while the field winding assembly 14 rotates.

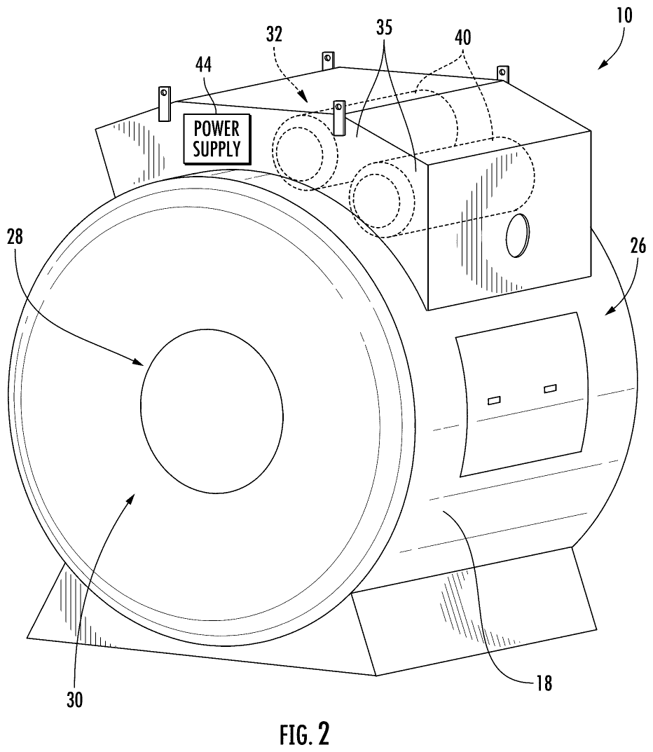

Referring now to FIGS. 2-4, various views of an embodiment of the superconducting machine 10 are illustrated for purposes of describing operational and functional aspects of a superconducting machine according to the present disclosure.

As discussed, it should be understood that such superconducting machines described herein may be used in a variety of apparatuses or applications. In particular, superconducting machines may include or apply to, but should not be construed as limited to, renewable energy (e.g., such as wind power generation), magnetic resonance imaging (MRI) machines, nuclear magnetic resonance (NMR) spectrometers, superconducting generators or motors, non-superconducting generators or motors, mass spectrometers, fusion reactors, particle accelerators, levitation, guidance, and propulsion, and similar.

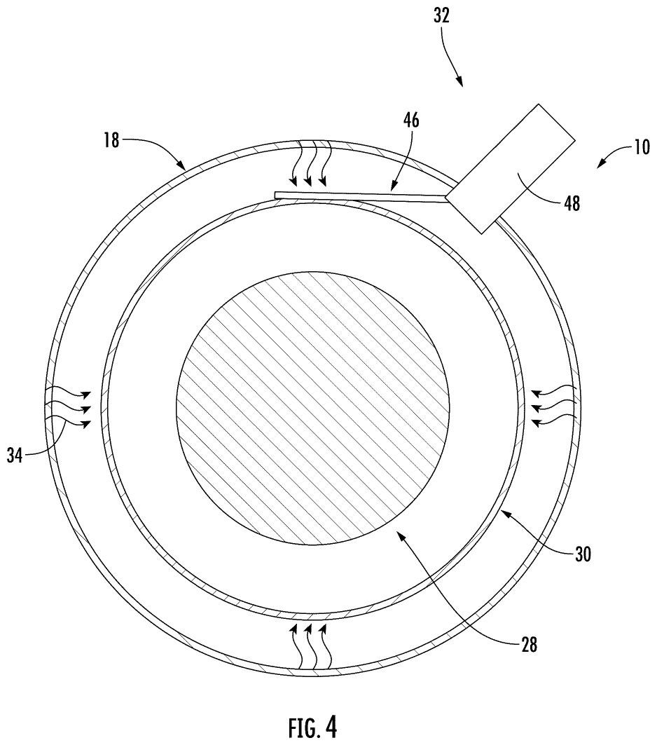

As shown particularly in FIGS. 2-5, the superconducting machine 10 includes the thermally insulated vacuum vessel 18, which is a component of a cryostat system. As used herein, a cryostat generally refers to a device used to maintain low cryogenic temperatures. In addition, as shown, the superconducting machine 10 also generally includes a cold mass 28, a thermal shield 30 arranged circumferentially and encompassing the cold mass 28, and a cooling system 32. In further embodiments, the cold mass 28 may be a stationary component, such as the field winding assembly 14 that provides a stationary magnetic field within which the armature winding assembly 12 rotates. Moreover, the cold mass 28 may include the plurality of conducting coils 16 (FIG. 1). Furthermore, as an example, the vacuum vessel 18 may be a non-rotatable component supporting the field winding assembly 14. Thus, in such embodiments, the rotatable component may be oriented to rotate relative to the non-rotatable component during operation of the superconducting machine 10. In such embodiments, as shown in FIG. 4, the thermal shield 30 is configured to intercept and/or block radiation (as indicated by arrows 34) from the vacuum vessel 18.

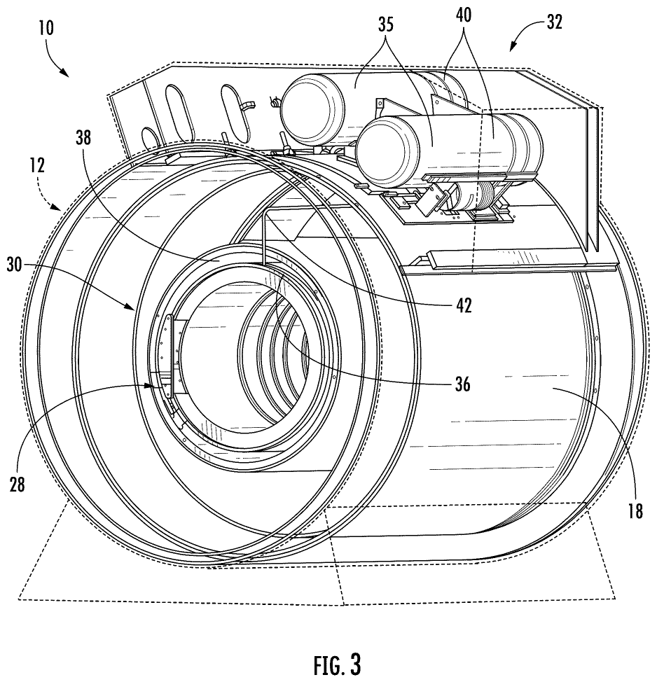

Still referring to FIGS. 2-5, the cooling system 32 is configured to provide a cooling fluid 35, such as a cryogen, to at least one superconducting circuit 36 or coil arranged inside the vacuum vessel 18, supported by an internal structure 38 (FIG. 3) and in fluid communication with one or more cryogen tanks 40. Accordingly, in such embodiments, the vacuum vessel 18 insulates the superconducting circuit(s) 36 such that the circuit(s) 36 may be cooled to near absolute zero, e.g., to 10 Kelvin (K) and preferably to 4 K. For example, in an embodiment, the superconducting circuit(s) 36 may include a plurality of conduits 42 that carry the cryogen from the cryogen tank 40 to the internal structure 38. More particularly, as shown, the superconducting circuit(s) 36 may be arranged in a coil shape and may be configured for generating a magnetic field. As shown particularly in FIG. 2, the superconducting machine 10 may further include a power supply 44 for energizing the superconducting circuit(s) 36.

Thus, in its superconducting state, the superconducting circuit(s) 36 does not have an electrical resistance and therefore can conduct much larger electric currents than ordinary wires, creating intense magnetic fields. Furthermore, during operation, the superconducting circuit(s) 36 must be cooled below their critical temperature, the temperature at which the wire material changes from the normal resistive state and becomes a superconductor. Typically, the superconducting circuit(s) 36 are cooled to temperatures significantly below their critical temperature, because the lower the temperature, the better superconductive windings work-the higher the currents and magnetic fields they can stand without returning to their non-superconductive state.

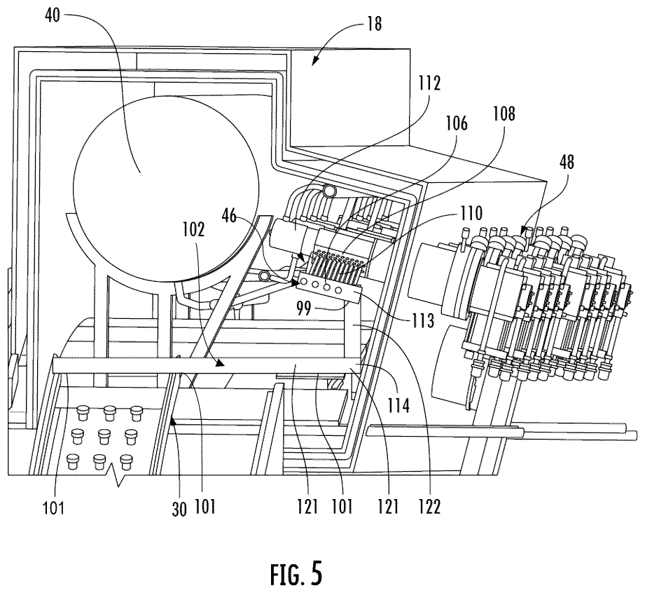

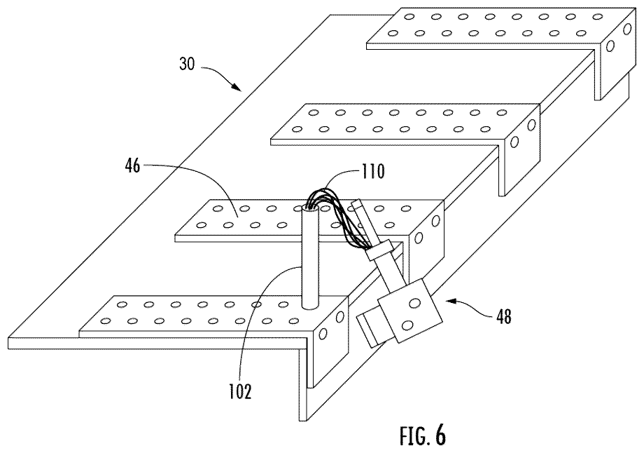

The cooling system 32 may be secured to the thermal shield 30 of the superconducting machine 10 via a thermal connection, which may include at least one thermal busbar 46 thermally coupled to the thermal shield 30 and a cryocooler 48 of the cooling system 32, as shown in FIG. 4. In other embodiments, as shown in FIGS. 5 and 6 for example, the cryocooler 48 is thermally coupled to the thermal busbar 46 via at least one flexible connector 110 (FIGS. 5 and 6). For example, the thermal busbar 46 may be secured across a plurality of the flexible connector(s) 110. In such embodiments, the flexible connector(s) 110 may be braided wires, foil members, or heat pipes. Thus, heat is removed via the thermal busbar 46 and the flexible connectors 110 to the cooling system 32. In addition, as shown particularly in FIG. 5, the cooling system 32 further includes an extension member 102 thermally configured between the thermal busbar(s) 46 and the thermal shield 30 so as to position the thermal busbar(s) 46 at a location that minimizes a length of the flexible connector 110. In particular, as shown in FIG. 5, the extension member 102 is secured (e.g., via a fastener) at a first end 99 to one or more locations 106 along the thermal busbar 46 and at one or more locations 101 (e.g., via fasteners) to the thermal shield 30. In such embodiments, the extension member 102 may be a separate component from the thermal busbar 46. Further, the extension member 102 may be sized such that the second end 101 extends from the vacuum vessel 18 across the entire length of the thermal shield 30. By doing this, the extension member 102 may better extract heat from the thermal shield 30 by transferring heat axially from the thermal shield 30 to the thermal busbar 46. Moreover, by sizing the extension member 102 in such a manner, the extension member 102 may be able to maintain gas flow with the cryocooler 48 and the cryogen tanks 40.

If the flexible connector(s) 110 are too long, the delta temperature and thermal conduction losses of the thermal busbar 46, the flexible connector(s) 110, or any of the other components of the cooling system 32 may be too high, thereby resulting in cooling power lost. Accordingly, reducing the length of the flexible connector(s) 110 may be useful to minimize the delta temperature of such components. Thus, the extension member 102 is configured to effectively reduce the length of the flexible connector(s) 110, and consequently, thermal contact resistances may also be reduced. For example, in an embodiment, the extension member 102 may allow for the length of the flexible connector(s) 110 to be from about 50 millimeters (mm) to less than about 300 mm.

Furthermore, in certain embodiments, the extension member 102 may be a monolithic component, such as a pedestal arrangement, or a segmented component formed of a plurality of member components. For example, if the extension member 102 is segmented (as in the embodiment of FIG. 5), the extension member may include a first member component 121 attached to the thermal shield 30 and a second member component 122 attached to the first member component 121 and the thermal busbar 46. Thus, where the extension member 102 is segmented (as shown in FIG. 5), the member components may be joined together at one or more hinge joints 113 such that the shape of the extension member 102 can be modified as needed to connect the extension member 102 between the flexible connectors 110 (via the thermal busbar 46) to the thermal shield 30. However, when the extension member 102 is a monolithic component, the extension member may be an integral, singular, and continuous piece of material.

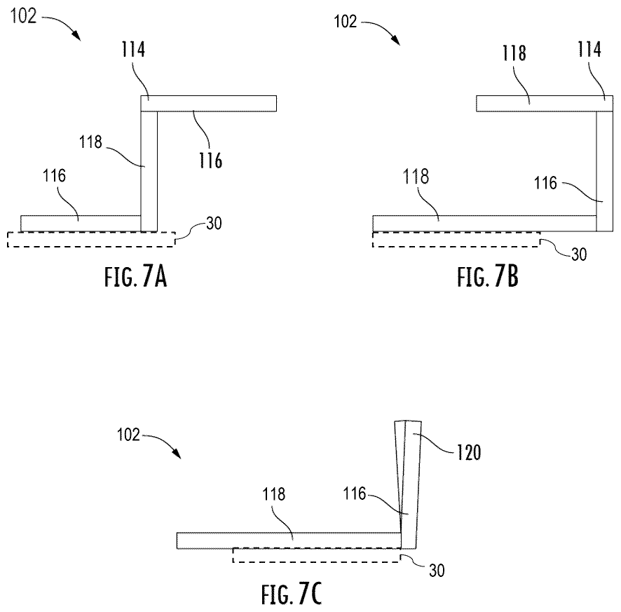

Moreover, in certain embodiments, the extension member 102 described herein may have any suitable shape with any number of bends so as to effectively reduce the length of the flexible connector 110. For example, as shown in FIGS. 5 and 7, the extension member 102 may include at least one bend 114.

Referring now to FIG. 6, a different embodiment is depicted wherein the extension member 102 may take the form of a pedestal that is a free-standing, I-shaped member that extends from the thermal busbar 46 (connected to the thermal shield 30) and connects directly to the flexible connector(s) 110. An extension member 102 without a bend may be particularly useful if the distance between the thermal busbar 46 and the cryocooler 48 is sufficient enough to reduce delta temperature and thermal contact resistances. In this configuration, the flexible connector(s) 110 may be attached to the extension member 102. However, if the distance needs to be reduced further, a bend(s) may be provided.

In such embodiments where a bend(s) 114 is provided, the bend(s) 114 may define an angle (i.e., between two member components 116, 118 of the extension member 102) ranging from about 30 degrees to about 150 degrees. Thus, by providing the extension member 102 with at least one bend 114, various shapes can be formed to route the extension member 102 from the flexible connectors 110 to the thermal shield 30. For example, in an embodiment, as shown in FIGS. 5 and 7B, the extension member 102 may have a generally J-shape (or U-shape) so as to route the extension member 102 from the flexible connectors 110 to the thermal shield 30. Moreover, and referring now to FIGS. 7A-7C, example shapes of an extension member 102 according to the present disclosure are presented. In particular, as shown in FIG. 7A, the extension member 102 has a generally S-shape or Z-shape. In another embodiment, as shown in FIG. 7C, the extension member 102 has a generally L-shape. In addition, as shown in FIG. 7C, the extension member 102 may also include a twist 120 or twisted portion to further assist with reducing the length of the flexible connectors 110. For example, the twist 120 or twisted portion may result in the extension member 102 to more directly face the flexible connector(s) 110 or the thermal busbar 46 such that the flexible connector(s) or thermal busbar 46 may be uniformly attached to the extension member 102.

In addition, in certain embodiments, the twist 120 is configured to provide a wider surface in relation to the flexible connectors 110. The wider surface may allow for flexible connectors 110 to be attached with approximately the same length. By having the flexible connectors 110 approximately the same length, thermal contact resistances may be made uniform across all the connectors, and the overall efficiency of the cooling system may be increased as a result.

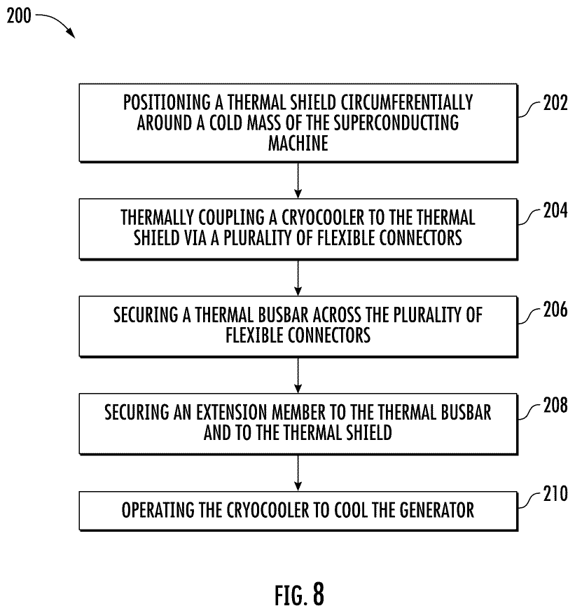

Referring now to FIG. 8, a flow diagram of an embodiment of a method of cooling a generator is illustrated according to the present disclosure. In general, the method 200 will be described herein with reference to the superconducting machine 10 and the related cooling systems 32 described herein with reference to FIGS. 1-7. However, it should be appreciated by those of ordinary skill in the art that the disclosed method 200 may generally be utilized with any superconducting machine having any suitable configuration. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown at (202), the method 200 includes positioning a thermal shield circumferentially around a cold mass of the superconducting machine. As shown at (204), the method 200 includes thermally coupling a cryocooler to the thermal shield via a plurality of flexible connectors. As shown at (206), the method includes securing a thermal busbar across the plurality of flexible connectors. As shown at (208), the method 200 includes securing an extension member to the thermal busbar and to the thermal shield such that the extension member positions the thermal busbar at a location with respect to the cryocooler that minimizes a length of the plurality of flexible connectors. As shown at (210), the method 200 includes operating the cryocooler to cool the generator.

The skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Various aspects and embodiments of the present invention are defined by the following numbered clauses:
Clause 1. A cooling system for a superconducting machine, the cooling system comprising:
   a thermal shield;
   a cryocooler thermally coupled to the thermal shield via at least one thermal busbar and at least one flexible connector, the at least one thermal busbar secured across the at least one flexible connector; and
   an extension member secured to the at least one thermal busbar and the thermal shield so as to position the at least one thermal busbar at a location that minimizes a length of the at least one flexible connector.
Clause 2. The cooling system of clause 1, wherein the extension member comprises at least one bend.
Clause 3. The cooling system of clause 2, wherein the at least one bend defines an angle ranging from about 30 degrees to about 150 degrees.
Clause 4. The cooling system of clauses 2-3, wherein the extension member comprises a plurality of member components secured together to form the least one bend.
Clause 5. The cooling system of any of the preceding clauses, wherein at least a portion of the extension member is integral with the at least one thermal busbar.
Clause 6. The cooling system of any of the preceding clauses, wherein the extension member is a separate component from the at least one thermal busbar.
Clause 7. The cooling system of any of the preceding clauses, wherein the at least one flexible connector comprises a plurality of flexible connectors, wherein the extension member comprises a twisted portion comprising a wider surface to allow the plurality of flexible connectors to have approximately a same length.
Clause 8. The cooling system of any of the preceding clauses, wherein the at least one flexible connector comprises a length ranging from about 50 millimeters (mm) to less than about 300 mm.
Clause 9. The cooling system of any of the preceding clauses, wherein the at least one flexible connector comprises one of a braided wire, a foil member, or a heat pipe.
Clause 10. The cooling system of any of the preceding clauses, wherein the extension member defines one of an L-shape, a U-shape, an I-shape, or an S-shape.
Clause 11. A method of cooling a superconducting machine, the method comprising:
   positioning a thermal shield circumferentially around a cold mass of the superconducting machine;
   thermally coupling a cryocooler to the thermal shield via a plurality of flexible connectors;
   securing a thermal busbar across the plurality of flexible connectors;
   securing an extension member to the thermal busbar and to the thermal shield, wherein the extension member positions the thermal busbar at a location with respect to the cryocooler that minimizes a length of the plurality of flexible connectors; and
   operating the cryocooler to cool the superconducting machine.
Clause 12. The method of clause 11, wherein the extension member comprises at least one bend.
Clause 13. The method of clause 12, wherein the at least one bend defines an angle ranging from about 30 degrees to about 150 degrees.
Clause 14. The method of clauses 12-13, wherein the extension member comprises a plurality of member components secured together to form the least one bend.
Clause 15. The method of clauses 11-14, wherein the extension member comprises a twisted portion comprising a wider surface to allow the plurality of flexible connectors to have approximately a same length.
Clause 16. The method of clauses 11-15, the length of the plurality comprise a range from about 50 millimeters (mm) to less than about 300 mm.
Clause 17. The method of clauses 11-16, wherein the extension member is integral with the thermal busbar.
Clause 18. The method of clauses 11-17, wherein the plurality of flexible connectors comprise one of braided wires, foil members or heat pipes.
Clause 19. The method of clauses 11-18, wherein the extension member defines at least one of an L-shape, a U-shape, an I-shape, or an S-shape.
Clause 20. A superconducting machine, comprising:
   a cold mass comprising a plurality of superconducting coils;
   a thermal shield encompassing the cold mass;
   a cryocooler thermally coupled to the thermal shield via at least one thermal busbar and at least one flexible connector, the at least one thermal busbar secured across the at least one flexible connector; and
   an extension member secured to the at least one thermal busbar and the thermal shield so as to position the at least one thermal busbar at a location that minimizes a length of the at least one flexible connector.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooling system for a superconducting machine, the cooling system comprising:
a thermal shield;
a cryocooler thermally coupled to the thermal shield via at least one thermal busbar and at least one flexible connector, the at least one thermal busbar secured across the at least one flexible connector; and
an extension member secured to the at least one thermal busbar and the thermal shield so as to position the at least one thermal busbar at a location that minimizes a length of the at least one flexible connector.

2. The cooling system of claim 1, wherein the extension member comprises at least one bend.

3. The cooling system of claim 2, wherein the at least one bend defines an angle ranging from about 30 degrees to about 150 degrees.

4. The cooling system of claim 2, wherein the extension member comprises a plurality of member components secured together to form the least one bend.

5. The cooling system of claim 1, wherein at least a portion of the extension member is integral with the at least one thermal busbar.

6. The cooling system of claim 1, wherein the extension member is a separate component from the at least one thermal busbar.

7. The cooling system of claim 1, wherein the at least one flexible connector comprises a plurality of flexible connectors, wherein the extension member comprises a twisted portion comprising a wider surface to allow the plurality of flexible connectors to have approximately a same length.

8. The cooling system of claim 1, wherein the at least one flexible connector comprises a length ranging from about 50 millimeters (mm) to less than about 300 mm.

9. The cooling system of claim 1, wherein the at least one flexible connector comprises one of a braided wire, a foil member, or a heat pipe.

10. The cooling system of claim 1, wherein the extension member defines one of an L-shape, a U-shape, an I-shape, or an S-shape.

11. A method of cooling a superconducting machine, the method comprising:
positioning a thermal shield circumferentially around a cold mass of the superconducting machine;
thermally coupling a cryocooler to the thermal shield via a plurality of flexible connectors;
securing a thermal busbar across the plurality of flexible connectors;
securing an extension member to the thermal busbar and to the thermal shield, wherein the extension member positions the thermal busbar at a location with respect to the cryocooler that minimizes a length of the plurality of flexible connectors; and
operating the cryocooler to cool the superconducting machine.

12. The method of claim 11, wherein the extension member comprises at least one bend.

13. The method of claim 12, wherein the at least one bend defines an angle ranging from about 30 degrees to about 150 degrees.

14. The method of claim 12, wherein the extension member comprises a plurality of member components secured together to form the least one bend.

15. The method of claim 11, wherein the extension member comprises a twisted portion comprising a wider surface to allow the plurality of flexible connectors to have approximately a same length.

16. The method of claim 11, the length of the plurality comprise a range from about 50 millimeters (mm) to less than about 300 mm.

17. The method of claim 11, wherein the extension member is integral with the thermal busbar.

18. The method of claim 11, wherein the plurality of flexible connectors comprise one of braided wires, foil members or heat pipes.

19. The method of claim 11, wherein the extension member defines at least one of an L-shape, a U-shape, an I-shape, or an S-shape.

20. A superconducting machine, comprising:
a cold mass comprising a plurality of superconducting coils;
a thermal shield encompassing the cold mass;
a cryocooler thermally coupled to the thermal shield via at least one thermal busbar and at least one flexible connector, the at least one thermal busbar secured across the at least one flexible connector; and
an extension member secured to the at least one thermal busbar and the thermal shield so as to position the at least one thermal busbar at a location that minimizes a length of the at least one flexible connector.
